(19) United States
(12) Patent Application Publication
(10) Pub. No.: US 2025/0048011 A1
(43) Pub. Date: Feb. 6, 2025

(54) SOUND OUTPUT APPARATUS

(71) Applicant: HUAWEI TECHNOLOGIES CO., LTD., Shenzhen, Guangdong (CN)

(72) Inventors: Lei WANG, Shanghai (CN); Chao XU, Shanghai (CN); Renxuan QIN, Shanghai (CN); Tienan ZHANG, Dongguan (CN)

(21) Appl. No.: 18/697,296

(22) PCT Filed: Sep. 27, 2022
(86) PCT No.: PCT/CN2022/121708

§ 371 Date: Mar. 29, 2024

(30) Foreign Application Priority Data
Sep. 30, 2021 (CN) 202111163731.4

(51) Int. Cl. H04R 1/10; G10K 11/178; H04R 1/24

(52) U.S. Cl. CPC H04R 1/1016; G10K 11/17873; H04R 1/1075; H04R 1/24; G10K 2210/1081; G10K 2210/3027; H04R 2201/003; H04R 2460/01; H04R 2460/11

(57) ABSTRACT

This application provides a sound output apparatus including a housing, a first speaker, and a second speaker. A sound outlet and a first air vent that are spaced are disposed on the housing. A first channel and a second channel that are separated are disposed on the housing. A rear cavity of the first speaker communicates with the outside of an earphone through the first channel and the first air vent of the housing. The second speaker is located on a side that is of the first speaker and that is away from the sound outlet. A front cavity of the second speaker communicates with the outside of the earphone through the second channel and the sound outlet of the housing, so that low-frequency performance of the first speaker is improved.

This application is a national stage of International Application No. PCT/CN2022/121708, filed on Sep. 27, 2022, which claims priority to Chinese Patent Application No., 202111163731.4, filed on Sep. 30, 2021. Both of the aforementioned applications are hereby incorporated by reference in their entireties.

### TECHNICAL FIELD

This application relates to the field of electro-acoustic technologies, and in particular, to a sound output apparatus.

### BACKGROUND

As an important consumer electronic product, earphones are widely used in daily life. With the development of multi-unit earphone technologies, multi-unit earphones are in favor with an increasing quantity of users. The multi-unit earphone means that a plurality of sound-generating units are used to emit sound waves to cover a plurality of frequency bands. However, in a procedure in which a plurality of sound-generating units of a conventional multi-unit earphone emit sound waves, the sound waves easily interfere with each other, resulting in poor quality of sound emitted by the multi-unit earphone.

### SUMMARY

This application provides a sound output apparatus. The sound output apparatus helps improve sound quality.

This application provides a sound output apparatus. The sound output apparatus includes a housing, a first speaker, and a second speaker. The housing encloses an inner cavity. A sound outlet and a first air vent that are spaced are disposed on the housing. The inner cavity of the housing communicates with the outside of the housing through both the sound outlet and the first air vent. A first channel and a second channel that are separated (or isolated from each other) are disposed on the housing. It may be understood that the separation may mean that the first channel does not communicate with the second channel. The first channel communicates with the first air vent, and the second channel communicates with the sound outlet.

The first speaker is fastened to the inner cavity of the housing. A sound-emitting side of the first speaker faces the sound outlet. A rear cavity of the first speaker communicates with the first channel. The second speaker is fastened to the inner cavity of the housing, and is located on a side that is of the first speaker and that is away from the sound outlet. A front cavity of the second speaker communicates with the second channel.

It may be understood that because the first channel communicates with the first air vent, and the rear cavity of the first speaker communicates with the first channel, the rear cavity of the first speaker may communicate with the outside of the sound output apparatus through the first channel and the first air vent. In this way, the rear cavity of the first speaker is in an open state, and a volume of the rear cavity of the first speaker is greatly expanded. This improves equivalent compliance of the rear cavity of the first speaker, and further improves low-frequency sound performance of the first speaker.

In addition, the rear cavity of the first speaker communicates with the outside of the earphone through the first channel and the first air vent of the housing. The second speaker is located on a side that is of the first speaker and that is away from the sound outlet. The front cavity of the second speaker communicates with the outside of the earphone through the second channel and the sound outlet of the housing. In this way, the rear cavity of the first speaker may be separated from the front cavity of the second speaker, and a sound wave in the rear cavity of the first speaker does not easily interfere with a sound wave in the front cavity of the second speaker. This improves sound quality of the second speaker.

In an embodiment, the sound output apparatus further includes a first support. The first support is mounted in the inner cavity of the housing. The first channel is disposed on the first support. The first speaker is fastened to the first support. The first speaker and the first support enclose a first cavity. The first cavity is a part of the rear cavity of the first speaker.

It may be understood that the first support may be configured to fasten the first speaker, and also to provide, for the rear cavity of the first speaker, an independent channel that may communicate with the outside of the sound output apparatus. The first support has an all-in-one function.

In an embodiment, the second channel is disposed on the first support. The second speaker is fastened to the first support. The second speaker and the first support enclose a second cavity. The second cavity is separated from the first cavity. The second cavity is a part of the front cavity of the second speaker.

It may be understood that the first support may be configured to fasten the second speaker, and also to provide, for the front cavity of the second speaker, an independent channel that may communicate with the outside of the sound output apparatus. The first support has the all-in-one function.

In addition, both the first speaker and the second speaker are fastened to the first support, so that the first speaker, the second speaker, and the first support may be arranged more compactly.

In an embodiment, the first speaker is a micro-electro-mechanical systems (MEMS) speaker, and the second speaker is a moving-coil speaker. It may be understood that the MEMS speaker has an advantage of high frequency. The moving-coil speaker has an advantage of low-to-medium frequency. In this way, the sound output apparatus has advantages of low, medium and high frequency. The sound output apparatus covers a broad frequency band.

In an embodiment, operating frequency bands of the first speaker and the second speaker are in a range of 20 Hz to 20 kHz. The sound output apparatus may cover low, medium, and high frequency bands. The sound output apparatus covers a broad frequency band.

In an embodiment, the sound output apparatus further includes a feedforward reference microphone. The feedforward reference microphone is fastened to the first support. The feedforward reference microphone is configured to capture noise in an external environment of the sound output apparatus. The sound output apparatus further includes a signal processing circuit. The signal processing circuit is located in the inner cavity of the housing. The signal processing circuit is configured to receive the noise captured by the feedforward reference microphone, and perform signal processing on the noise, to convert a phase of the noise into an opposite phase. The signal processing circuit is further configured to transmit opposite-phase noise to the first speaker or the second speaker, so that the first speaker or the second speaker emits a opposite-phase sound wave.

It may be understood that the first support may further provide a set position for the feedforward reference microphone. The first support has the all-in-one function. In addition, an example in which the sound output apparatus is an earphone is used. The feedforward reference microphone and the signal processing circuit cooperate with the first speaker, so that when the earphone is worn in the ear, noise in the ear canal may be eliminated. Alternatively, the feedforward reference microphone and the signal processing circuit cooperate with the second speaker, so that when the earphone is worn in the ear, noise in the ear canal may be eliminated.

In an embodiment, the sound output apparatus further includes a first mesh. The first mesh is fastened between the housing and the first support, and covers the first air vent and the first channel. In this way, the first mesh may filter out impurities (such as dust) from air outside the sound output apparatus, and also adjust acoustic impedance of air in the rear cavity of the first speaker to an extent. This improves sound quality of the sound output apparatus.

In an embodiment, the first support and a housing of the first speaker are in an integrally formed structure. In this way, integrity between the first support and the first speaker is improved. In addition, compared with a solution in which the first support and the first speaker are separately formed, and the first support then fastens the first speaker, an embodiment requires fewer processes and lower costs.

In an embodiment, the sound output apparatus further includes a second support. A second support channel is disposed on the second support. The second support channel communicates with the sound outlet. The second support fastens the first speaker. The second support channel is a part of a front cavity of the first speaker.

It may be understood that the first speaker is fastened to the second support on which the second support channel is disposed, so that the sound wave emitted by the first speaker may be propagated to the sound output apparatus through the second support channel and the sound outlet. The first speaker has an independent sound output channel, and the sound wave emitted by the first speaker and the sound wave emitted by the second speaker do not easily interfere with each other. This helps improve quality of sound output by the sound output apparatus.

In an embodiment, the second support includes a fastening part and an extending part. The fastening part includes a first surface and a second surface that are disposed opposite to each other. The extending part is fastened to the first surface. A first opening of the second support channel is located on the second surface of the fastening part. A second opening of the second support channel is located on a surface that is of the extending part and that is away from the fastening part. The first speaker is fastened to the second surface of the fastening part. It may be understood that in an embodiment, the second support has a simple structure.

In an embodiment, the housing is further provided with a second air vent. The second air vent is spaced from the first air vent and the sound outlet. The inner cavity of the housing communicates with the outside of the housing through the second air vent. The sound output apparatus further includes a third support. A third support channel is disposed on the third support. The third support fastens the second speaker. The third support and the second speaker enclose a third cavity. The third cavity is a part of a rear cavity of the second speaker. The third cavity communicates with the second air vent through the third support channel.

It may be understood that the second air vent of the housing communicates with the rear cavity of the second speaker. Air in the rear cavity of the second speaker may communicate with air outside the sound output apparatus. The rear cavity of the second speaker forms an open state. This improves equivalent compliance of the rear cavity of the second speaker, and improves low-frequency performance of the second speaker.

In an embodiment, the front cavity and the rear cavity of the second speaker are separated from each other, so that a propagation path of the sound wave in the front cavity of the second speaker may be separated from a propagation path of a sound wave in the rear cavity of the second speaker. In this way, the sound wave in the rear cavity of the second speaker does not easily interfere with the sound wave in the front cavity of the second speaker. In other words, an acoustic short circuit does not easily occur in the second speaker because the sound wave in the front cavity of the second speaker is not coupled with the sound wave in the rear cavity of the second speaker. This improves sound quality of the front cavity of the second speaker, and avoids performance attenuation of the sound in the front cavity of the second speaker.

In addition, the rear cavity of the second speaker is separated from the rear cavity of the first speaker, so that the propagation path of the sound wave in the rear cavity of the second speaker may be separated from a propagation path of the sound wave in the rear cavity of the first speaker.

In an embodiment, the sound output apparatus further includes a third support. A third support channel is disposed on the third support. The third support fastens the second speaker. The third support channel communicates with the first air vent. The third support and the second speaker enclose a third cavity. The third cavity is a part of a rear cavity of the second speaker. The third support channel communicates with the first channel through the third cavity.

It may be understood that the first air vent of the housing communicates with the rear cavity of the second speaker. Air in the rear cavity of the second speaker may communicate with air outside the sound output apparatus. The rear cavity of the second speaker forms the open state. This improves equivalent compliance of the rear cavity of the second speaker, and improves low-frequency performance of the second speaker.

In an embodiment, the front cavity and the rear cavity of the second speaker are separated from each other, so that a propagation path of the sound wave in the front cavity of the second speaker may be separated from a propagation path of a sound wave in the rear cavity of the second speaker. In this way, the sound wave in the rear cavity of the second speaker does not easily interfere with the sound wave in the front cavity of the second speaker. In other words, an acoustic short circuit does not easily occur in the second speaker because the sound wave in the front cavity of the second speaker is not coupled with the sound wave in the rear cavity of the second speaker. This improves sound quality of the front cavity of the second speaker, and avoids the performance attenuation of the sound in the front cavity of the second speaker.

In addition, the rear cavity of the second speaker is separated from the rear cavity of the first speaker, so that the propagation path of the sound wave in the rear cavity of the second speaker may be separated from a propagation path of the sound wave in the rear cavity of the first speaker.

In addition, in an embodiment, a part of the channel connecting the rear cavity of the first speaker to the outside of the sound output apparatus is the same as a part of the channel connecting the rear cavity of the second speaker to the outside of the sound output apparatus. In other words, the propagation path of the sound wave in the rear cavity of the first speaker overlaps at least partially with the propagation path of the sound wave in the rear cavity of the second speaker. In this way, the additional second air vent does not need to be provided for the housing. This helps improve overall strength of the housing and appearance consistency of the housing.

In an embodiment, the sound output apparatus further includes a fourth mesh. The fourth mesh is fastened between the first support and the third support, and covers an opening that is of the first channel and through which the first channel communicates with the third cavity. In this way, the fourth mesh may adjust the acoustic impedance of the air in the rear cavity of the first speaker to an extent. This improves sound quality of the sound output apparatus.

In an embodiment, the housing is provided with a third air vent. The third air vent is spaced from the sound outlet and the first air vent. The inner cavity of the housing communicates with the outside of the housing through the third air vent. An air discharge channel is further disposed on the first support. The air discharge channel is spaced from the first channel and the first cavity. The front cavity of the second speaker communicates with the third air vent through the air discharge channel.

It may be understood that an example in which the sound output apparatus is an earphone is used for description. When the earphone is worn, air in an ear canal is continuously compressed as the sound outlet is plugged into the ear canal. For example, in a procedure of wearing an in-ear earphone, the sound outlet seals the ear canal, and pressure in the ear canal increases. This causes a problem of uncomfortable wearing, and even causes damage to an eardrum of a user. In addition, because the ear canal communicates with the front cavity of the first speaker and the front cavity of the second speaker, pressure in the front cavity of the first speaker and pressure in the front cavity of the second speaker also increase with the pressure in the ear canal. This also affects acoustic performance of a bass frequency band of the earphone to an extent. However, in this implementation, the front cavity of the second speaker communicates with the outside of the earphone through the air discharge channel and the third air vent. In this way, when the earphone is worn, an air flow in the ear canal is discharged to the external environment of the earphone through the air discharge channel and the third air vent in a procedure of continuously plugging the sound outlet into the ear canal. This quickly balances the pressure in the ear canal, the pressure in the front cavity of the first speaker, and the pressure in the front cavity of the second speaker, to avoid the problem of uncomfortable wearing in the procedure of wearing the earphone. In addition, the pressure in the front cavity of the first speaker and the pressure in the front cavity of the second speaker do not easily increase with the pressure in the ear canal. This ensures that acoustic performance of the earphone is not easily affected.

In an embodiment, the third air vent is disposed away from the sound outlet of the housing. In this way, when the earphone is worn on the ear, an inner wall of a cavum conchae or an inner wall of the ear canal does not block the third air vent, to avoid a problem that the third air vent cannot communicate with the outside of the earphone. This ensures stability of pressure relief in the front cavity of the second speaker.

In addition, when the earphone includes the feedforward reference microphone, noise in the external environment of the earphone may directly enter the front cavity of the second speaker through the air discharge channel and the third air vent, and enter the feedforward reference microphone and a residual noise reference microphone. In other words, the air discharge channel and the third air vent may provide a new sound propagation path in which the noise is directly transferred from the external environment of the earphone to the residual noise reference microphone. This improves coherence between the noise captured by the residual noise reference microphone and the noise captured by the feedforward reference microphone. In this way, the signal processing circuit performs phase-inversion fitting on the residual signal more accurately, and noise reduction effect is further improved.

In an embodiment, the sound output apparatus is a wireless earphone. In an embodiment, quality of sound output by the wireless earphone is improved, and low-frequency sound performance of the first speaker of the wireless earphone is improved.

### BRIEF DESCRIPTION OF DRAWINGS

FIG. 1 is a schematic diagram of a structure of a part of a sound output apparatus according to an embodiment of this application;

FIG. 2 is a schematic exploded view of a part of an earphone shown in FIG. 1;

FIG. 3 is a schematic cross-sectional view of a part of a first speaker shown in FIG. 2 in an embodiment;

FIG. 4a is a schematic exploded view of a housing shown in FIG. 2 from an angle in an embodiment;

FIG. 4b is a schematic exploded view of the housing shown in FIG. 4a from another angle;

FIG. 5 is a schematic diagram of a structure of a first support shown in FIG. 2 from different angles in an embodiment;

FIG. 6 is a schematic diagram of a structure of the first support shown in FIG. 5 from different angles;

FIG. 7a is a schematic cross-sectional view of a part of the earphone shown in FIG. 1 from a first angle in an embodiment;

FIG. 7b is a schematic cross-sectional view of the part of the earphone shown in FIG. 1 from a second angle;

FIG. 8 is a schematic diagram of a structure of the part of the earphone shown in FIG. 1 in an embodiment;

FIG. 9 is a schematic cross-sectional view of the part of the earphone shown in FIG. 1 from a first angle in an embodiment;

FIG. 10 is a schematic cross-sectional view of the part of the earphone shown in FIG. 1 from a first angle in another embodiment;

FIG. 11 is a schematic diagram of a structure of a second support shown in FIG. 2 from different angles in an embodiment;

FIG. 12 is a schematic cross-sectional view of the part of the earphone shown in FIG. 1 from a first angle in another embodiment;

FIG. 13 is a schematic cross-sectional view of the part of the earphone shown in FIG. 1 from a first angle in another embodiment;

FIG. 14 is a schematic diagram of a structure of the part of the earphone shown in FIG. 1 in an embodiment;

FIG. 15 is a schematic cross-sectional view of the part of the earphone shown in FIG. 1 from a third angle in an embodiment;

FIG. 16 is a schematic diagram of a structure of a third support shown in FIG. 2 from different angles in an embodiment;

FIG. 17 is a schematic diagram of a structure of the part of the earphone shown in FIG. 1 in an embodiment;

FIG. 18 is a schematic cross-sectional view of the part of the earphone shown in FIG. 1 from a first angle in another embodiment;

FIG. 19 is a schematic cross-sectional view of the part of the earphone shown in FIG. 1 from a first angle in another embodiment;

FIG. 20 is a schematic cross-sectional view of the part of the earphone shown in FIG. 1 from a first angle in another embodiment;

FIG. 21 is a schematic cross-sectional view of the part of the earphone shown in FIG. 1 from a first angle in another embodiment;

FIG. 22 is a schematic cross-sectional view of the part of the earphone shown in FIG. 1 from a first angle in another embodiment; and

FIG. 23 is a schematic cross-sectional view of the part of the earphone shown in FIG. 1 from a first angle in another embodiment.

### DESCRIPTION OF EMBODIMENTS

The following describes embodiments of this application with reference to the accompanying drawings in embodiments of this application.

In the descriptions of embodiments of this application, unless otherwise explicitly specified and limited, terms “installation” and “connection” should be understood in a broad sense. For example, the “connection” may be a detachable connection or a non-detachable connection, or may be a direct connection or an indirect connection through an intermediate medium. “Fastened” means a connection to each other with a changeless relative position relationship after the connection. Orientation terms mentioned in embodiments of this application, for example, “inside”, “outside”, “front”, and “back”, are merely directions based on the accompanying drawings. Therefore, the orientation terms are used to better and more clearly describe and understand embodiments of this application, instead of indicating or implying that a specified apparatus or element must have an orientation, and be constructed and operated in the specific orientation. Therefore, this cannot be understood as a limitation on embodiments of this application.

In embodiments of this application, terms “first”, “second”, “third” and “fourth” are merely intended for a purpose of description, and shall not be understood as an indication or implication of relative importance or implicit indication of the number of indicated technical features. Therefore, a feature limited by “first”, “second”, “third”, or “fourth” may explicitly or implicitly include one or more features.

The term “and/or” in embodiments of this application describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

Reference to “an embodiment”, “some embodiments”, or the like described in this specification indicates that one or more embodiments of this application include a feature, structure, or characteristic described with reference to the embodiment. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise emphasized in another manner. The terms “include”, “comprises” and “have”, and their variants all mean “include but are not limited to”, unless otherwise emphasized in another manner.

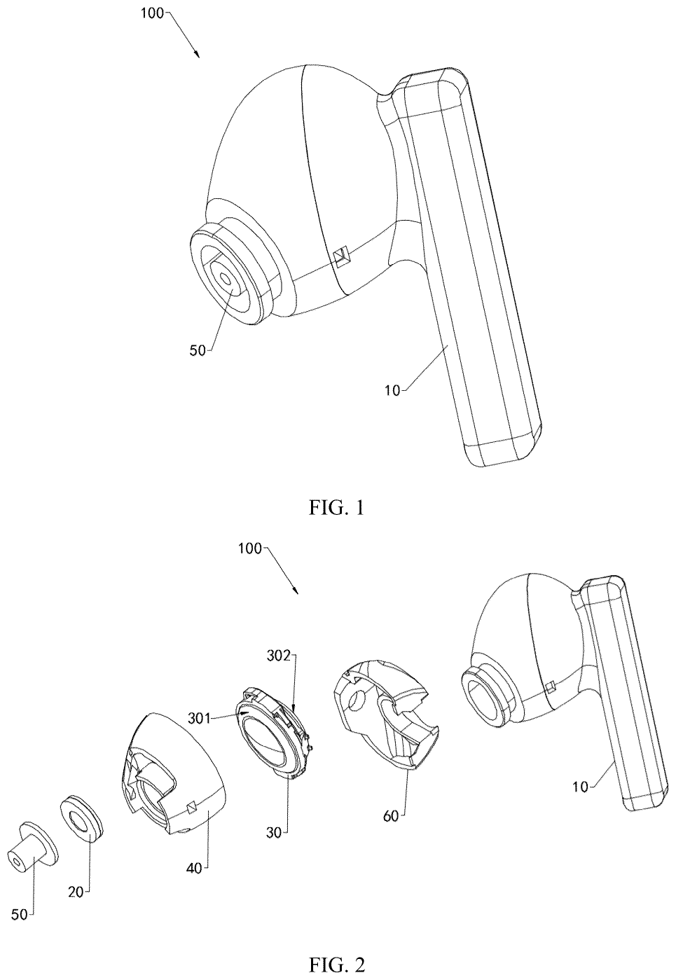

FIG. 1 is a schematic diagram of a structure of a part of a sound output apparatus 100 according to an embodiment of this application. The sound output apparatus 100 is configured to output sound, for example, to play music, play voice information, or make a call. The sound output apparatus 100 may be an earphone, a player, or another device. An example in which the sound output apparatus 100 in an embodiment shown in FIG. 1 is an earphone is used for description. In the following, reference numerals of the sound output apparatus 100 are used as reference numerals of the earphone.

In an embodiment, the earphone 100 may be a wireless earphone, or may be a wired earphone. When the earphone 100 is a wireless earphone, the earphone 100 may be communicatively connected to another electronic device. The another electronic device may be a device having a communication function, for example, an earphone, a mobile phone, a watch, a tablet computer (tablet personal computer), a laptop computer, a vehicle-mounted device, a wearable device, augmented reality (AR) glasses, an AR helmet, virtual reality (VR) glasses, or a VR helmet. The earphone 100 in the embodiment shown in FIG. 1 is a wireless earphone, for example, a Bluetooth earbud. In an embodiment, the earphone 100 is a TWS (true wireless stereo, true wireless stereo) earphone. It should be noted that FIG. 1 merely shows one earphone 100 schematically (in other words, the earphone 100 includes at least one earbud). In an embodiment, the earphone 100 may alternatively include two or more earbuds, where the two earbuds respectively provide sounds for the left ear and the right ear.

In addition, the earphone 100 may be a half in-ear earphone, an in-ear earphone, or an over-ear headphone.

Refer to FIG. 2. With reference to FIG. 1, FIG. 2 is a schematic exploded view of a part of the earphone 100 shown in FIG. 1. The earphone 100 may include a housing 10 (also referred to as an earphone housing), a first speaker 20 (also referred to as a first sound-generating unit), a second speaker 30 (also referred to as a second sound-generating unit), a first support 40 (also referred to as a first supporting frame or a first fastening frame), a second support 50 (also referred to as a second supporting frame or a second fastening frame), and a third support 60 (also referred to as a third supporting frame or a third fastening frame). It should be noted that FIG. 1, FIG. 2, and the following accompanying drawings merely show some components schematically. Actual shapes and sizes of these components are not limited by FIG. 1, FIG. 2, and the following accompanying drawings. In addition, in an embodiment, the earphone 100 may further include more or fewer components. For example, in some embodiments, the earphone 100 may include either/neither of the second support 50 and the third support 60. Alternatively, the earphone 100 may include either/neither of the first support 40 and the third support 60. Alternatively, the earphone 100 may include either/neither of the first support 40 and the second support 50.

In an embodiment, the first speaker 20 may be a micro-electro-mechanical systems (MEMS) speaker (also referred to as a micro-electro-mechanical systems sound-generating unit), a moving-coil speaker (also referred to as a moving-coil sound-generating unit), a moving-iron speaker (also referred to as a moving-iron sound-generating unit), or the like. An example in which the first speaker 20 in an embodiment is a MEMS speaker is used for description. The second speaker 30 may be a moving-coil speaker, a MEMS speaker, a moving-iron speaker, or the like. An example in which the second speaker 30 in an embodiment is a moving-iron speaker is used for description. The moving-coil speaker may be a speaker in which according to the principle of electromagnetic induction, ampere force exerts on a voice coil in a magnetic field when the speaker is powered on, and the voice coil drives a diaphragm to vibrate to generate sound. The moving-coil speaker may include a voice coil, a magnetic circuit system (including a magnet), a diaphragm, a basket, and the like. The moving-iron speaker may be a speaker in which an inner armature moves in a magnetic field to drive a diaphragm to generate sound. The moving-iron speaker may include an iron piece, a magnet, and a diaphragm.

In an embodiment, a structure including two speakers is used in the earphone 100. In other words, the earphone 100 includes the MEMS speaker and the moving-coil speaker, and the earphone 100 is a multi-unit earphone. The MEMS speaker of the earphone 100 has an advantage of a high frequency. The moving-coil speaker of the earphone 100 has advantages of medium and low frequencies. In this way, the earphone 100 has advantages of low, medium, and high frequencies. The earphone 100 covers a broad frequency band. For example, an operating frequency band of the earphone 100 is in a range of 20 Hz to 20 kHz. The earphone 100 may emit a sound wave in a low frequency band (20 Hz to 150 Hz), a low-to-medium frequency band (150 Hz to 500 Hz), a medium-to-high frequency band (500 Hz to 5 kHz), and a high frequency band (5 kHz to 20 kHz). In addition, the MEMS speaker of the earphone 100 has an advantage of high sensitivity at a high frequency. In this way, the earphone 100 may provide better sound quality experience for a user, especially experience in a high fidelity (Hi-Fi) scenario, a game scenario, and the like.

In an embodiment, a structure including more than two speakers is alternatively used in the earphone 100. In other words, the earphone 100 may further include a third speaker, a fourth speaker, . . . , and an M^{th} speaker. M is an integer greater than 2. It may be understood that advantages of the speakers are used, so that the earphone 100 has advantages such as a broad frequency band and high sensitivity. This further improves user experience. For example, when the earphone 100 further includes the third speaker. The third speaker may be a moving-iron speaker, so that the earphone 100 may cover a broader frequency band.

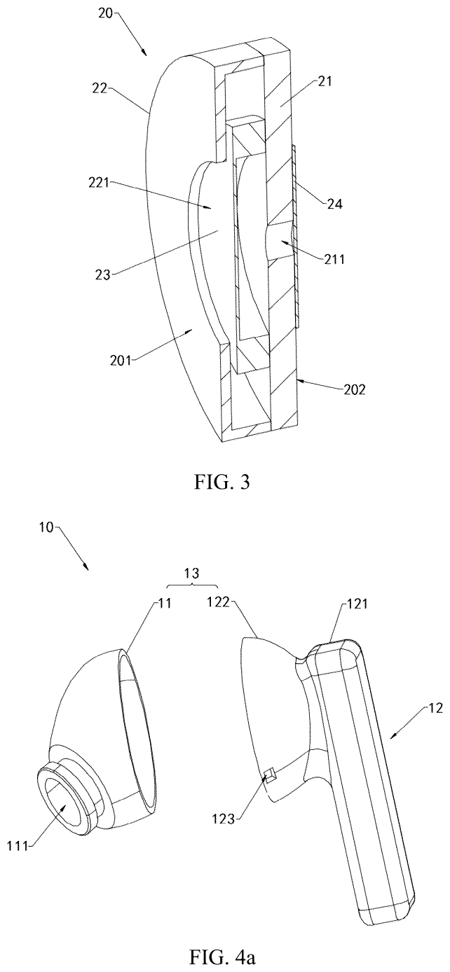

FIG. 3 is a schematic cross-sectional view of a part of the first speaker 20 shown in FIG. 2 in an embodiment. The first speaker 20 is a MEMS speaker. The MEMS speaker may be a piezoelectric speaker manufactured by using a micro-electro-mechanical systems technology. In some embodiments, the MEMS speaker may include a substrate 21, a housing 22, and a diaphragm assembly 23. The substrate 21 may be a circuit board. In addition, the MEMS speaker may further include a speaker mesh 24. The housing 22 is fastened to the substrate 21. The housing 22 and the circuit board 21 enclose an inner cavity of the MEMS speaker. The housing 22 is provided with a sound hole 221. The sound hole 221 communicates with the inner cavity of the MEMS speaker. In addition, a rear vent 211 is disposed on the substrate 21. The rear vent 211 communicates with the inner cavity of the MEMS speaker.

In addition, the diaphragm assembly 23 is fastened to the substrate 21, and is located in the inner cavity of the MEMS speaker. It may be understood that the diaphragm assembly 23 may include a diaphragm (not shown in the figure) and a piezoelectric thin film (not shown in the figure). The piezoelectric thin film may be fastened to the diaphragm. The piezoelectric thin film is used as a driving component. According to the principle of inverse piezoelectric effect of the piezoelectric thin film, the piezoelectric thin film deforms under an action of an electric field, to drive the diaphragm to vibrate, so as to drive air to generate sound.

In addition, the speaker mesh 24 is fastened to the substrate 21, and covers the rear vent 211 of the substrate 21. It may be understood that the speaker mesh 24 may filter out impurities (for example, dust) from air outside the MEMS speaker, and also adjust acoustic impedance of air in a rear cavity of the MEMS speaker to an extent. This improves sound quality of the MEMS speaker. A position of the speaker mesh 24 is not limited to the position outside the MEMS speaker shown in FIG. 3. The speaker mesh 24 may alternatively be located in the rear vent 211 or in the internal cavity of the MEMS speaker. In another implementation, a shape of the speaker mesh 24 may alternatively be an irregular shape. A part of the speaker mesh 24 is disposed outside the MEMS speaker, and a part of the speaker mesh 24 is disposed in the rear vent 211.

It may be understood that when the MEMS speaker is in a working state, the piezoelectric thin film of the diaphragm assembly 23 drives the diaphragm to vibrate in the inner cavity of the MEMS speaker, so as to drive air to generate sound. In this case, a sound wave emitted by the MEMS speaker is propagated out of the MEMS speaker through the sound hole 221 of the housing 22, to provide the sound for a human ear. In addition, the rear vent 211 is disposed, so that the rear cavity of the MEMS speaker is in an open state. This improves low-frequency performance of the MEMS speaker.

In an embodiment, the first speaker 20 (that is, the MEMS speaker) has a front side 201 and a back side 202 that are disposed opposite to each other. It may be understood that the front side 201 of the first speaker 20 may be a surface on which a sound-emitting side (that is, the sound hole 221) of the first speaker 20 is located. The back side 202 of the first speaker 20 may be opposite to the surface on which the sound-emitting side of the first speaker 20 is located.

In an embodiment, a front cavity of the first speaker 20 includes a cavity enclosed by the diaphragm of the diaphragm assembly 23, the housing 22, and the substrate 21. The cavity communicates with the sound hole 221. The rear cavity of the first speaker 20 includes a cavity enclosed by the diaphragm of the diaphragm assembly 23 and the substrate 21. The cavity communicates with the rear vent 211.

Refer to FIG. 2 again. The second speaker 30 also has a front side 301 and a back side 302 that are disposed opposite to each other. It may be understood that the front side 301 of the second speaker 30 may be a surface on which a sound-emitting side of the second speaker 30 is located. The back side 302 of the second speaker 30 may be opposite to the surface on which the sound-emitting side of the second speaker 30 is located.

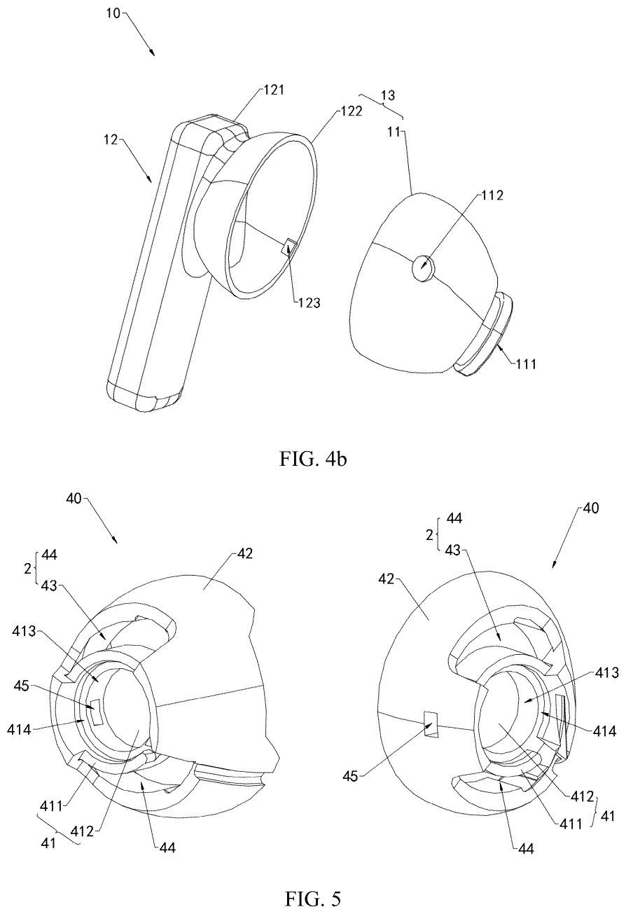

Refer to FIG. 4a and FIG. 4b. With reference to FIG. 2, FIG. 4a is a schematic exploded view of the housing 10 shown in FIG. 2 from an angle in an embodiment. FIG. 4b is a schematic exploded view of the housing 10 shown in FIG. 4a from another angle. The housing 10 includes a front housing 11 and a rear housing 12. The front housing 11 is fastened to the rear housing 12. For example, the front housing 11 may be fastened to the rear housing 12 through snap-fitting, bonding, or the like. The front housing 11 and the rear housing 12 may enclose an inner cavity of the earphone 100. The inner cavity of the earphone 100 may be further configured to accommodate components such as a power supply and a signal processing circuit (for example, a filter).

In addition, the rear housing 12 includes a stem 121 and a boss 122. The front housing 11 is fastened to the boss 122 of the rear housing 12. The front housing 11 and the boss 122 of the rear housing 12 form an earbud 13 of the earphone 100. It may be understood that when the earphone 100 is worn on an ear, the earbud 13 of the earphone 100 may be placed in a cavum conchae of the ear. The stem 121 of the earphone 100 may be placed outside the cavum conchae. In this way, the user easily takes off the earphone 100. At least a part of the front housing 11 of the earbud 13 may also extend into an external auditory canal of the ear. At least a part of an outer surface of the front housing 11 may be in contact with an inner wall of the external auditory canal, so that noise is isolated, and user experience is better.

Refer to FIG. 4a and FIG. 4b again. A sound outlet 111 may be disposed on the housing 10. For example, the sound outlet 111 is disposed on the front housing 11. The inner cavity of the earphone 100 communicates with the outside of the earphone 100 through the sound outlet 111. When the earphone 100 is worn on the ear, the sound outlet 111 may face the external auditory canal of the ear or extend into the external auditory canal of the ear. The sound wave emitted by the earphone 100 may pass through the sound outlet 111 to the external auditory canal of the ear.

In an embodiment, an eartip (or referred to as an earbud tip) (not shown in the figure) may be disposed on the sound outlet 111 of the earphone 100. When the sound outlet 111 extends into the external auditory canal, at least a part of the eartip may also extend into the external auditory canal, and the eartip may properly seal the external auditory canal, to better insulate noise, and improve user experience. For example, the eartip may be made of a soft material, for example, rubber. When the eartip extends into the external auditory canal, the eartip may be in contact with the inner wall of the external auditory canal and the like, and deform, to reduce pressure applied to the inner wall of the external auditory canal. In this way, the user is comfortable when wearing the earphone 100, and user experience of the user is improved.

Refer to FIG. 4a and FIG. 4b again. The boss 122 of the rear housing 12 is further provided with a first air vent 123. The first air vent 123 is spaced from the sound outlet 111. The inner cavity of the earphone 100 communicates with the outside of the earphone 100 through the first air vent 123. In addition, the front housing 11 is further provided with a second air vent 112. The second air vent 112 is spaced from the first air vent 123 and the sound outlet 111. The inner cavity of the earphone 100 communicates with the outside of the earphone 100 through the second air vent 112. In an embodiment, positions of the first air vent 123 and the second air vent 112 are not limited. For example, both the first air vent 123 and the second air vent 112 may be disposed on the boss 122 of the rear housing 12. The following describes functions of the first air vent 123 and the second air vent 112 in detail with reference to the related accompanying drawings. Details are not described herein.

In another embodiment, the housing 10 may alternatively be in another structure. This is not limited in this application.

FIG. 5 is a schematic diagram of a structure of the first support 40 shown in FIG. 2 from different angles in an embodiment. The first support 40 includes a middle part 41 and a circumferential part 42. The circumferential part 42 of the first support 40 is disposed around the middle part 41 of the first support 40.

The middle part 41 of the first support 40 includes a side wall 411 and a bottom wall 412. The side wall 411 is disposed around a circumference of the bottom wall 412, and is fastened to the circumference of the bottom wall 412. The side wall 411 and the bottom wall 412 enclose first space 413. An inner surface of the side wall 411 may be step-shaped. In other words, the inner surface of the side wall 411 has a step-shaped surface 414.

In an embodiment, a part of the side wall 411 is fastened to the circumferential part 42 of the first support 40. The part of the side wall 411 is spaced from the circumferential part 42 of the first support 40. In other words, a first through hole 43 and a second through hole 44 are formed between the part of the side wall 411 and the circumferential part 42 of the first support 40. The first through hole 43 and the second through hole 44 are a second channel 2. The first through hole 43 is spaced from the second through hole 44. In addition, the first through hole 43 and the second through hole 44 are further spaced from the first space 413. In other words, the side wall 411 separates the first through hole 43 and the second through hole 44 from the first space 413. It may be understood that structures (including shapes and sizes) of the first through hole 43 and the second through hole 44 may be the same, or may be different. It should be noted that the reference numeral 44 in the upper left corner of FIG. 5 indicates that both the reference numeral 44 and the reference numeral 43 relate to the reference numeral 2. There is a corresponding mark in FIG. 5 for the component indicated by 44.

In another embodiment, the first through hole 43 may alternatively communicate with the second through hole 44 to form a large through hole.

In another embodiment, the housing 10 may alternatively include the first through hole 43. In other words, the housing 10 does not include the second through hole 44. In this case, the first through hole 43 is the second channel 2.

In another embodiment, a third through hole, a fourth through hole, . . . , and an N^{th} through hole may be further formed between the part of the side wall 411 and the circumferential part 42 of the first support 40, where N is an integer greater than 2.

Refer to FIG. 5 again. A first channel 45 is disposed on the first support 40. The first channel 45 forms an opening on the inner surface of the side wall 411, and forms an opening on an outer surface of the circumferential part 42 of the first support 40. The first channel 45 and the second channel 2 (in other words, the first through hole 43 and the second through hole 44) are separated from each other. It may be understood that the separation may mean that the first channel 45 does not communicate with the second channel 2. In this way, the first space 413 may communicate with the outside of the first support 40 through the first channel 45.

Refer to FIG. 6. With reference to FIG. 5, FIG. 6 is a schematic diagram of a structure of the first support 40 shown in FIG. 5 from different angles. The circumferential part 42 of the first support 40 and the bottom wall 412 of the middle part 41 of the first support 40 enclose second space 415. The first through hole 43 communicates with the second through hole 44 through the second space 415. The bottom wall 412 of the middle part 41 separates the second space 415 from the first space 413.

In addition, the circumferential part 42 of the first support 40 has a first connection end face 421. For example, the first connection end face 421 is irregularly ring-shaped.

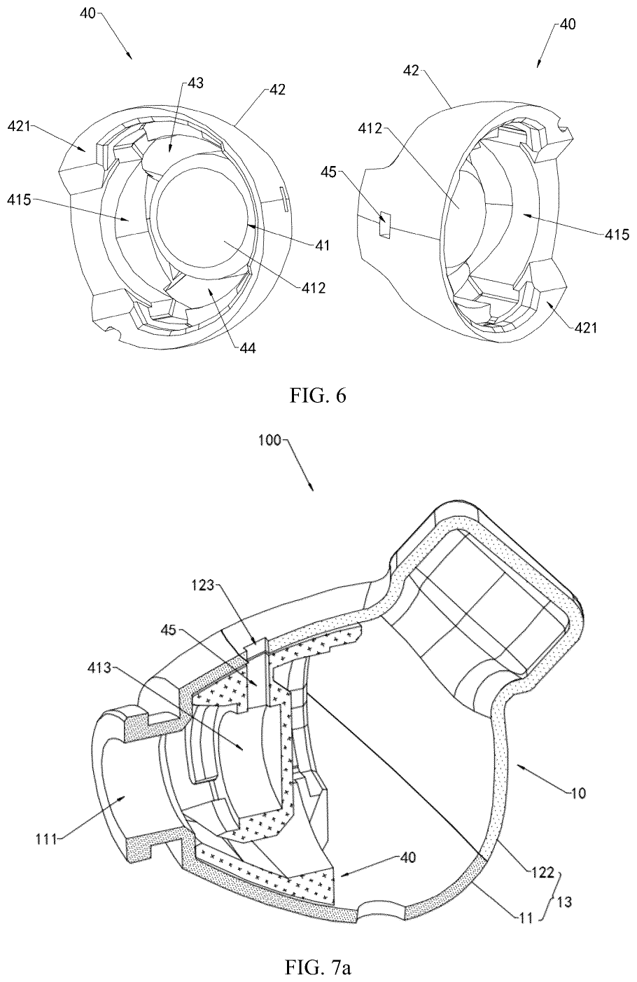

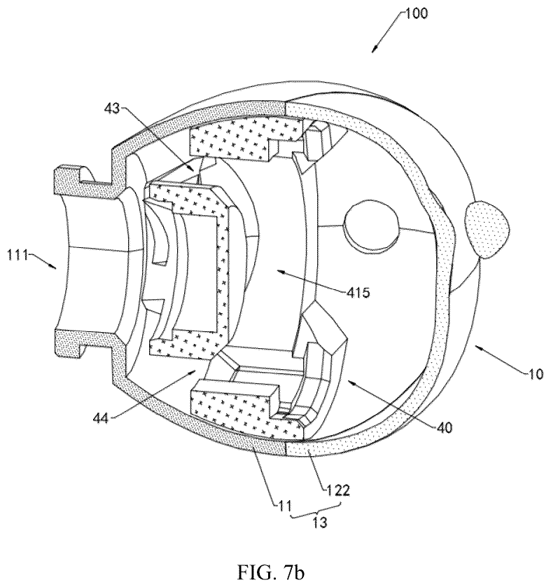

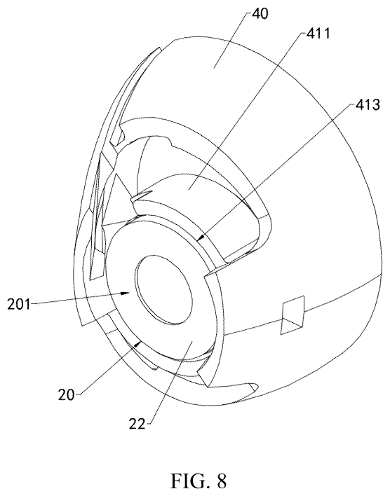

FIG. 7a is a schematic cross-sectional view of a part of the earphone 100 shown in FIG. 1 from a first angle in an embodiment. The first support 40 fastens the earbud 13 of the housing 10, and is located in an inner cavity of the housing 10. For example, a part of the first support 40 may fasten the front housing 11 through bonding or the like. A part of the first support 40 may fasten the boss 122 of the rear housing 12 through bonding or the like.

In addition, the first channel 45 of the first support 40 communicates with the first air vent 123 of the housing 10. In this way, the first space 413 may communicate with the outside of the earphone 100 through the first channel 45 and the first air vent 123.

In addition, the first space 413 faces the sound outlet 111 of the housing 10.

Refer to FIG. 7b. With reference to FIG. 7a, FIG. 7b is a schematic cross-sectional view of the part of the earphone 100 shown in FIG. 1 from a second angle. The second space 415 of the first support 40 may communicate with the outside of the earphone 100 through the first through hole 43, the second through hole 44, and the sound outlet 111 of the housing 10.

FIG. 8 is a schematic diagram of a structure of a part of the earphone 100 shown in FIG. 1 in an embodiment. The first speaker 20 is fastened to the first support 40. At least a part of the first speaker 20 is located in the first space 413. For example, the first speaker 20 may be fastened to the step-shaped surface 414 of the side wall 411 through bonding or the like (refer to FIG. 5). In another embodiment, the first support 40 and the first speaker 20 may form an integral structure. For example, the first support 40 may be a part of the housing 22 of the first speaker 20.

In an embodiment, the front side 201 of the first speaker 20 is opposite to the first space 413 of the first support 40. The back side 202 of the first speaker 20 (refer to FIG. 3) faces the first space 413 of the first support 40.

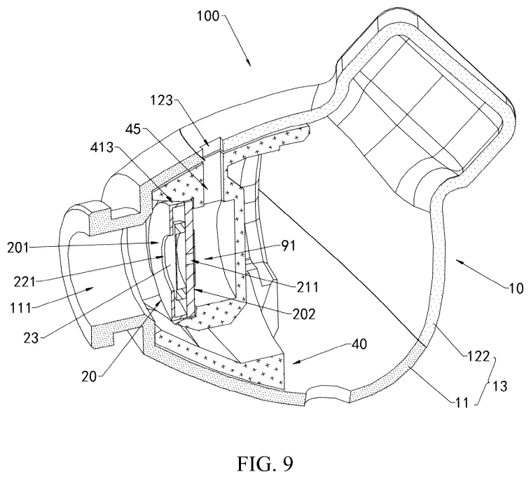

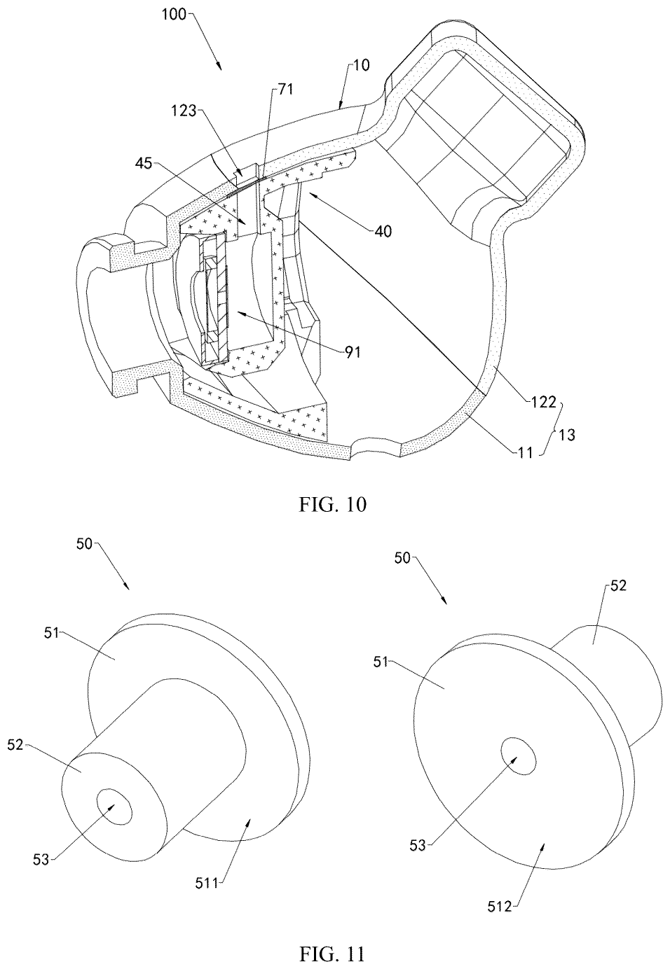

FIG. 9 is a schematic cross-sectional view of the part of the earphone 100 shown in FIG. 1 from a first angle in an embodiment. The front side 201 of the first speaker 20 faces the sound outlet 111 of the front housing 11. In other words, the sound hole 221 of the first speaker 20 faces the sound outlet 111 of the front housing 11. The back side 202 of the first speaker 20 is opposite to the sound outlet 111 of the front housing 11. In other words, the rear vent 211 of the first speaker 20 is opposite to the sound outlet 111 of the front housing 11.

In addition, the first speaker 20 and the first support 40 enclose a first cavity 91. The first cavity 91 is a part of the first space 413. For example, the first cavity 91 communicates with the rear vent 211 of the first speaker 20. In an embodiment, the first cavity 91 is a part of the rear cavity of the first speaker 20. It may be understood that the rear cavity of the first speaker 20 may be space enclosed by the diaphragm of the diaphragm assembly 23 and the first support 40. In an embodiment, with reference to FIG. 3, the rear cavity of the first speaker 20 includes the cavity enclosed by the diaphragm of the diaphragm assembly 23 and the substrate 21, the rear vent 211, and the first cavity 91. In another embodiment, when the earphone 100 does not include the first support 40, the rear cavity of the first speaker 20 may be a cavity enclosed by the diaphragm of the diaphragm assembly 23 and the housing 10.

In an embodiment, the first cavity 91 may communicate with the first air vent 123 through the first channel 45. In this way, the first cavity 91 may communicate with the outside of the earphone 100 through the first channel 45 and the first air vent 123. The rear cavity of the first speaker 20 may communicate with the outside of the earphone 100 through the first air vent 123 of the housing 10. In this way, the first air vent 123 is the rear vent of the rear cavity of the first speaker 20. The rear cavity of the first speaker 20 forms an open state. This may improve equivalent compliance of the rear cavity of the first speaker 20, and improve low-frequency performance of the first speaker 20.

On one hand, for the rear cavity, a relationship between equivalent compliance Cₘ, a cavity volume V₀, air density ρ, a sound velocity c in the air, and an equivalent area S of compressed air is as follows:

$${C}_{m} = \frac{{V}_{0}}{ρ {c}^{2} {S}^{2}}$$

It can be learned from the foregoing formula that the equivalent compliance Cₘ of the rear cavity is proportional to the cavity volume V₀. Therefore, the volume of the rear cavity of the first speaker 20 may be expanded by connecting the rear cavity of the first speaker 20 to the air in the outside. This improves equivalent compliance of the rear cavity of the first speaker 20, and further improves low-frequency sound performance of the first speaker 20. In particular, equivalent compliance of a rear cavity of a small-sized first speaker 20 (for example, a MEMS speaker) is improved more obviously. The size of the MEMS speaker is small, and a size of the rear cavity of a MEMS unit is also small. Consequently, equivalent compliance of the rear cavity of the MEMS speaker is low, and low-frequency displacement of the MEMS speaker is greatly reduced. This is unfavorable to low-frequency sound performance of the speaker. When the rear cavity of the MEMS speaker communicates with the air from the outside, a volume of the rear cavity of the MEMS speaker may be greatly increased. This greatly improves equivalent compliance of the rear cavity of the MEMS speaker, and further greatly increases the low-frequency displacement of the MEMS speaker, to help improve low-frequency sound performance of the MEMS speaker.

On the other hand, sound quality of the rear cavity of the MEMS speaker is adjusted properly (for example, a length and a radius of a sound conduit are adjusted), so that sound quality of the rear cavity and compliance of the diaphragm resonate at a low frequency. This further improves sound pressure of the first speaker 20 at a low frequency.

Sound quality of an ideal cylindrical sound conduit may be expressed as follows:

$$Mp = \frac{{ρ}_{0} 1}{{πa}^{2}}$$

Mp is the sound quality, ρ₀ is air density, l is the length of the sound conduit, and a is the radius of the sound conduit.

In another embodiment, when the earphone 100 does not include the first support 40, the rear cavity of the first speaker 20 may alternatively communicate with the first air vent 123 through a structure, for example, a pipe or a gap that is disposed on the housing 10. The structure, for example, the pipe or the gap that is disposed on the housing 10 is the first channel 45.

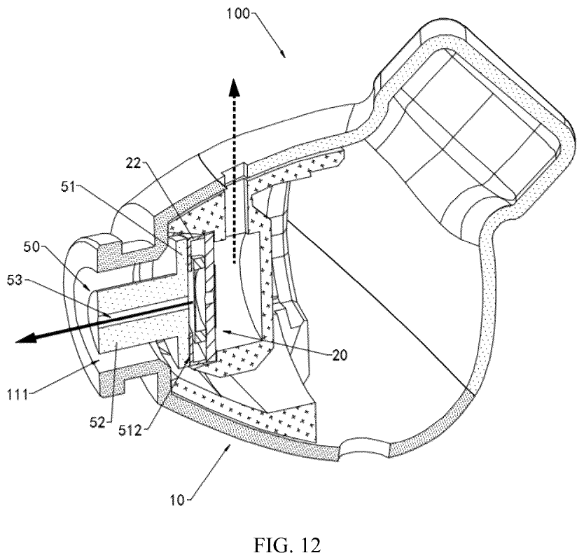

FIG. 10 is a schematic cross-sectional view of the part of the earphone 100 shown in FIG. 1 from a first angle in another embodiment. In an embodiment, the earphone 100 further includes a first mesh 71. The first mesh 71 is fastened between the housing 10 and the first support 40, and covers the first air vent 123 and the first channel 45. In this way, the first mesh 71 may filter out impurities (such as dust) from air outside the earphone 100, and also adjust acoustic impedance of air in the rear cavity of the first speaker 20 to an extent. This improves sound quality of the earphone 100. It may be understood that FIG. 10 shows that the first mesh 71 is located between the housing 10 and the first support 40. In another embodiment, the first mesh 71 may be located in the first cavity 91, located in the first channel 45, located in the first air vent 123, or located outside the earphone 100. In another embodiment, a mounting groove (not shown in the figure) is disposed on the housing 10, and the first mesh 71 is disposed in the mounting groove. In this way, the first mesh 71 is disposed on the housing 10, without increasing a thickness of the housing 10. In another embodiment, a mounting groove (not shown in the figure) may alternatively be disposed on the first support 40, and the first mesh 71 is disposed in the mounting groove. In another embodiment, a shape of the first mesh 71 is not limited to the shape shown in FIG. 10. For example, the shape of the first mesh 71 may alternatively be an irregular shape. A part of the first mesh 71 is located between the housing 10 and the first support 40. A part of the first mesh 71 is disposed in the first channel 45. A part of the first mesh 71 is disposed in the first air vent 123.

In an embodiment, the earphone 100 may further include a first sealing piece (not shown in the figure). The first sealing piece is fastened between the housing 10 and the first support 40. The first sealing piece may be disposed around the first mesh 71. It may be understood that the first sealing piece may cooperate with the first mesh 71, to further prevent impurities (for example, dust or water stains) outside the earphone 100 from entering the earphone 100 through a gap between the housing 10 and the first support 40.

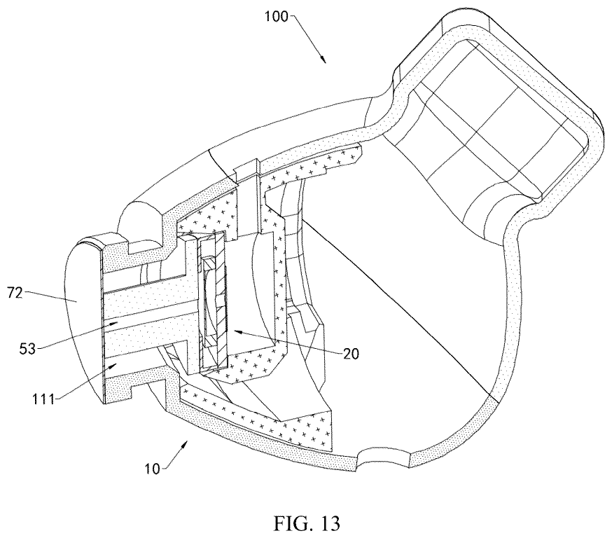

FIG. 11 is a schematic diagram of a structure of the second support 50 shown in FIG. 2 from different angles in an embodiment. The second support 50 includes a fastening part 51 and an extending part 52. For example, the fastening part 51 is disk-shaped. The extending part 52 is column-shaped. A diameter of the fastening part 51 is greater than a diameter of the extending part 52. In another embodiment, a diameter of the fastening part 51 may alternatively be less than or greater than a diameter of the extending part 52. In addition, shapes of the fastening part 51 and the extending part 52 are not specifically limited.

The fastening part 51 includes a first surface 511 and a second surface 512 that are disposed opposite to each other. The extending part 52 is fastened to the first surface 511.

In addition, a second support channel 53 is disposed on the second support 50. A first opening of the second support channel 53 is located on the second surface 512 of the fastening part 51. A second opening of the second support channel 53 is located on a surface that is of the extending part 52 and that is away from the fastening part 51.

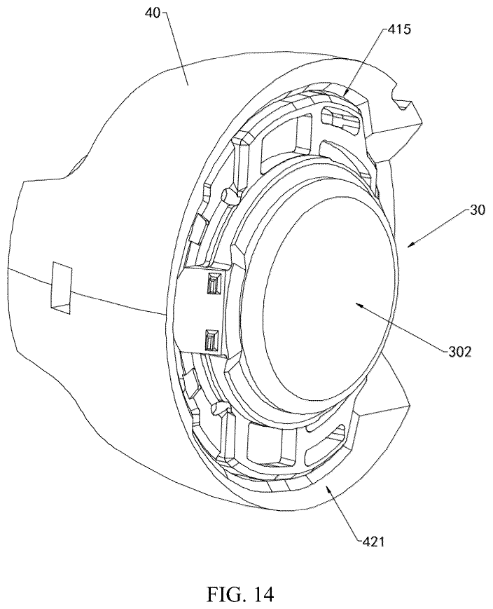

Refer to FIG. 12. With reference to FIG. 9 and FIG. 11, FIG. 12 is a schematic cross-sectional view of the part of the earphone 100 shown in FIG. 1 from a first angle according to another embodiment. The first speaker 20 is fastened to the second surface 512 of the fastening part 51 of the second support 50. For example, the housing 22 of the first speaker 20 may be fastened to the second surface 512 of the fastening part 51 of the second support 50. In an embodiment, when the first speaker 20 emits a sound wave, the sound wave emitted by the first speaker 20 may be propagated out of the earphone 100 through the second support channel 53. The second support channel 53 is a part of the front cavity of the first speaker 20. It may be understood that in an embodiment, the front cavity of the first speaker 20 may be a cavity enclosed by the diaphragm of the diaphragm assembly 23 and the second support 50. Refer to FIG. 3. The front cavity of the first speaker 20 includes a cavity enclosed by the diaphragm of the diaphragm assembly 23, the housing 22, and the substrate 21, the sound hole 221, and the second support channel 53. In another embodiment, when the earphone 100 does not include the second support 50, the front cavity of the first speaker 20 may be a cavity enclosed by the diaphragm of the diaphragm assembly 23 and the sound outlet 111 of the housing 10.

In another embodiment, the second support 50 and the first speaker 20 may also form an integral structure. For example, the second support 50 may be a part of the housing 22 of the first speaker 20.

It may be understood that the second support 50 on which the second support channel 53 is disposed fastens the first speaker 20, and the second support channel 53 of the second support 50 is used as a part of the front cavity of the first speaker 20, so that the first speaker 20 has an independent sound output channel, and the sound wave emitted by the first speaker 20 does not easily interfere with a sound wave emitted by another sound source.

In addition, a volume of the second support channel 53 of the second support 50 is smaller than a volume of a cavity enclosed by the sound outlet 111. Therefore, a volume of the front cavity of the first speaker 20 may be reduced by using the second support channel 53 of the second support 50 as a part of the front cavity of the first speaker 20.

In an embodiment, the front cavity and the rear cavity of the first speaker 20 are separated from each other, so that a propagation path (indicated by a solid line with an arrow in FIG. 12) of the sound wave in the front cavity of the first speaker 20 may be separated from a propagation path (indicated by a dashed line with an arrow in FIG. 12) of a sound wave in the rear cavity of the first speaker 20. In this way, the sound wave in the rear cavity of the first speaker 20 does not easily interfere with the sound wave in the front cavity of the first speaker 20. In other words, an acoustic short circuit does not easily occur in the first speaker 20 because the sound wave in the front cavity of the first speaker 20 is not coupled with the sound wave in the rear cavity of the first speaker 20. This improves sound quality of the front cavity of the first speaker 20, and avoids performance attenuation of the sound in the front cavity of the first speaker 20. In particular, sound quality of the first speaker 20 at a low frequency may be greatly improved, so that crossover frequency is flexibly selected for the earphone 100.

In an embodiment, the second support 50 is located in the housing 10. The second opening of the second support channel 53 may be flush with the sound outlet 111 of the housing 10. In this case, the sound wave emitted by the first speaker 20 is propagated out of the earphone 100 through the second support channel 53 of the second support 50. In another embodiment, the second opening of the second support channel 53 is not flush with the sound outlet 111 of the housing 10. The second opening of the second support channel 53 is located in the housing 10. In this case, the sound wave emitted by the first speaker 20 may be propagated out of the earphone 100 through the second support channel 53 of the second support 50 and the sound outlet 111 of the housing 10. In another embodiment, the second support 50 may extend out of the earphone 100 through the sound outlet 111 of the housing 10. In this case, the sound wave emitted by the first speaker 20 is propagated out of the earphone 100 through the second support channel 53 of the second support 50.

FIG. 13 is a schematic cross-sectional view of the part of the earphone 100 shown in FIG. 1 from a first angle according to another embodiment. The earphone 100 further includes a second mesh 72. The second mesh 72 is fastened to the housing 10, and covers the sound outlet 111 of the housing 10 and the second support channel 53. In this way, the second mesh 72 may filter out impurities (such as dust) from air outside the earphone 100, and also adjust acoustic impedance of air in the front cavity of the first speaker 20 to an extent. This improves sound quality of the earphone 100. It may be understood that FIG. 13 shows that the second mesh 72 is located outside the earphone 100. In another embodiment, the second mesh 72 may be located in the inner cavity of the earphone 100. In another embodiment, a mounting groove (not shown in the figure) is disposed on the housing 10, and the second mesh 72 is disposed in the mounting groove. In this way, the second mesh 72 is disposed on the housing 10, without increasing a thickness of the housing 10. In another embodiment, a shape of the second mesh 72 is not limited to the shape shown in FIG. 13. For example, the shape of the second mesh 72 may alternatively be an irregular shape. A part of the second mesh 72 is located outside the housing 10. A part of the second mesh 72 is disposed in the inner cavity of the housing 10.

Refer to FIG. 14. With reference to FIG. 6, FIG. 14 is a schematic diagram of a structure of the part of the earphone 100 shown in FIG. 1 in an embodiment. The second speaker 30 is fastened to the first support 40. At least a part of the second speaker 30 is located in the second space 415 of the first support 40. In an embodiment, a part of the second speaker 30 is located in the second space 415 of the first support 40, and a part of the second speaker 30 is disposed outside the first support 40. In another embodiment, the second speaker 30 may also be completely located in the second space 415 of the first support 40.

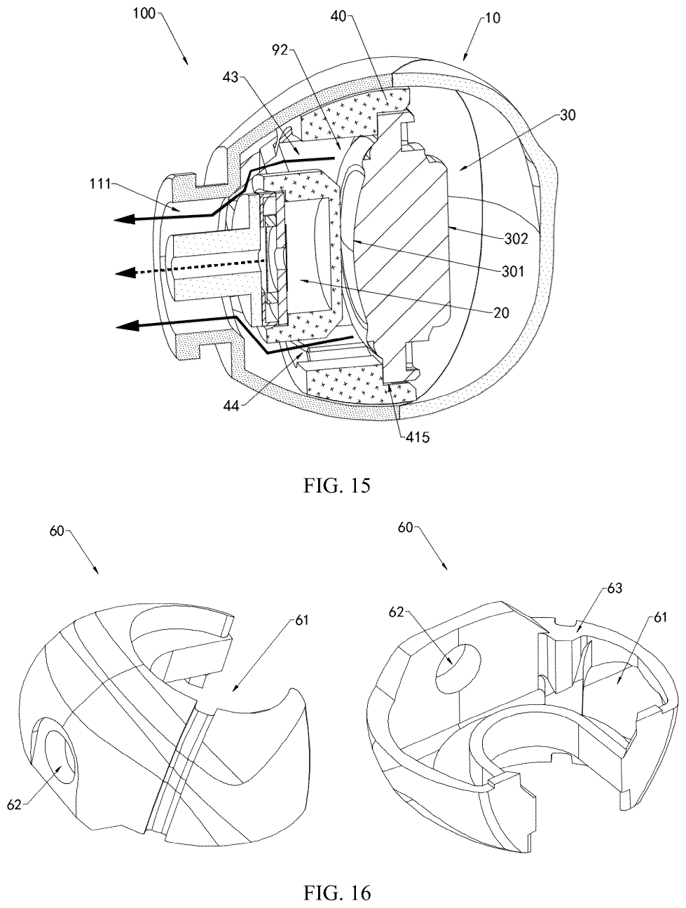

Refer to FIG. 15. With reference to FIG. 14, FIG. 15 is a schematic cross-sectional view of the part of the earphone 100 shown in FIG. 1 from a third angle in an embodiment. The front side 301 of the second speaker 30 is disposed facing the first speaker 20. The back side 302 of the second speaker 30 is disposed opposite to the first speaker 20. In this case, the second speaker 30 is located on a side that is of the first speaker 20 and that is away from the sound outlet 111 of the housing 10. The second speaker 30 and the first support 40 enclose a second cavity 92. The second cavity 92 is spaced from the first cavity 91. The second cavity 92 is a part of the second space 415. The second cavity 92 is a part of a front cavity of the second speaker 30. It may be understood that in an embodiment, the front cavity of the second speaker 30 may be a cavity enclosed by the diaphragm of the second speaker 30 and the first support 40.

The first through hole 43 of the first support 40 communicates with the second through hole 44 of the first support 40 through the second cavity 92. In this way, the second cavity 92 may communicate with the outside of the earphone 100 through the first through hole 43 of the first support 40, the second through hole 44 of the first support 40, and the sound outlet 111 of the housing 10. The sound wave emitted by the second speaker 30 may be propagated out of the earphone 100 through the second cavity 92, the first through hole 43, the second through hole 44, and the sound outlet 111. The sound wave emitted by the second speaker 30 detours around the first support 40 and the first speaker 20, and is propagated out of the earphone 100 through the sound outlet 111.

It may be understood that in an embodiment, the front cavity of the second speaker 30 is separated from the front cavity of the first speaker 20, so that a propagation path (indicated by a solid line with an arrow in FIG. 15) of the sound wave emitted by the second speaker 30 may be separated from a propagation path (indicated by a dashed line with an arrow in FIG. 15) of the sound wave emitted by the first speaker 20. In this way, on one hand, the sound wave emitted by the second speaker 30 does not easily interfere with the sound wave emitted by the first speaker 20. This improves sound quality of the front cavity of the first speaker 20 and the sound in the front cavity of the second speaker 30. On the other side, because the front cavity of the first speaker 20 may be disposed independently, a sound resistance, a high frequency width, and loudness of the front cavity of the first speaker 20 may be relatively easy to optimize. In addition, because the front cavity of the second speaker 30 is separately disposed, it may be easy to optimize a value of acoustic impedance, a low-to-medium frequency width, and loudness of the front cavity of the second speaker 30.

Refer to FIG. 15 again, and refer to FIG. 12. The front cavity of the second speaker 30 may alternatively be separated from the rear cavity of the first speaker 20. In other words, the front cavity of the second speaker 30 is isolated from the rear cavity of the first speaker 20, and the front cavity of the second speaker 30 does no communicate with the rear cavity of the first speaker 20. In this way, the sound wave in the front cavity of the second speaker 30 may be separated from the sound wave in the rear cavity of the first speaker 20. In this way, the sound wave in the rear cavity of the first speaker 20 does not easily interfere with the sound wave in the front cavity of the second speaker 30. In other words, an acoustic short circuit does not easily occur in the second speaker 30 because the sound wave in the front cavity of the second speaker 30 is not coupled with the sound wave in the rear cavity of the first speaker 20. This improves sound quality of the front cavity of the second speaker 30.

In another embodiment, when the first support 40 is not provided with the first through hole 43 and the second through hole 44, the front cavity of the second speaker 30 may alternatively communicate with the sound outlet 111 through the gap between the first support 40 and the housing 10.

In another embodiment, when the earphone 100 does not include the first support 40, the front cavity of the second speaker 30 may alternatively communicate with the sound outlet 111 through a structure like a pipe or a gap that is on the housing 10. The structure like the pipe or the gap that is on the housing 10 is the second channel 2.

FIG. 16 is a schematic diagram of a structure of the third support 60 shown in FIG. 2 from different angles in an embodiment. The third support 60 bends to enclose third space 61. A third support channel 62 is disposed on the third support 60. The third space 61 communicates with the outside of the third support 60 through the third support channel 62. In addition, the third support 60 has a second connection end face 63. For example, the second connection end face 63 is irregularly ring-shaped.

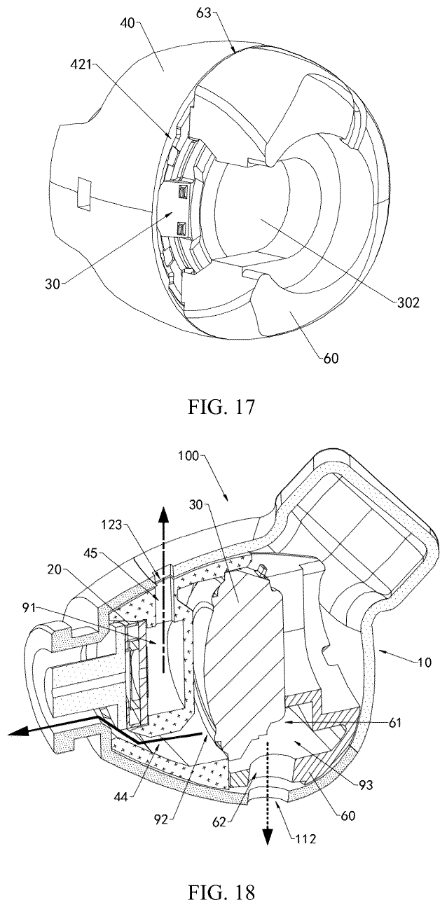

Refer to FIG. 17. With reference to FIG. 16, FIG. 17 is a schematic diagram of a structure of the part of the earphone 100 shown in FIG. 1 in an embodiment. The third support 60 fastens the second speaker 30. In an embodiment, the second speaker 30 is fastened to a part of the second connection end face 63 (FIG. 16 shows the second connection end face 63 at different angles) of the third support 60. The first connection end face 421 of the first support 40 (FIG. 14 shows the first connection end face 421 at different angles) is fastened to another part of the second connection end face 63 of the third support 60. In this case, the third support 60, the first support 40, and the second speaker 30 have good integrity and a firm connection. In another embodiment, the second speaker 30 is fastened to all or a part of the second connection end face 63 of the third support 60. In another embodiment, the third support 60 and the second speaker 30 may form an integral structure. For example, the third support 60 and a basket of the second speaker 30 may form an integral structure.

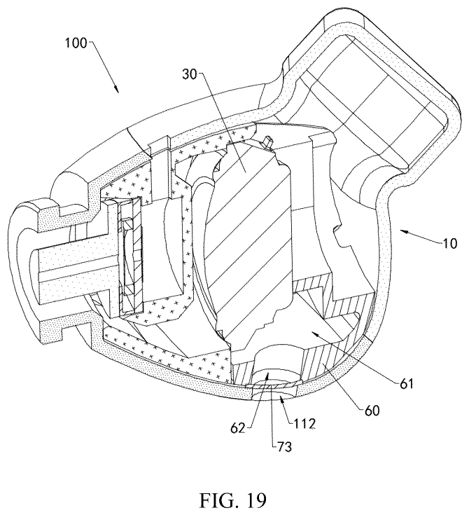

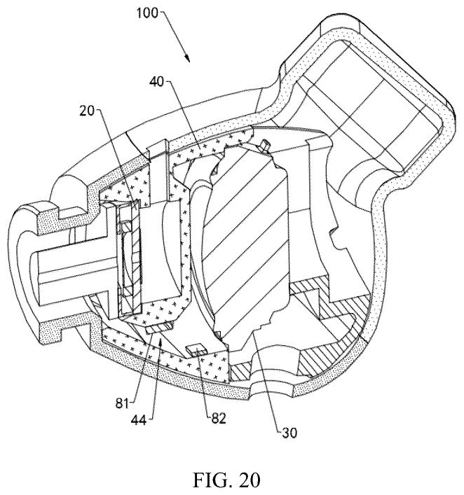

Refer to FIG. 18. With reference to FIG. 17, FIG. 18 is a schematic cross-sectional view of the part of the earphone 100 shown in FIG. 1 from a first angle according to another embodiment. A part of the second speaker 30 is located in the third space 61 of the third support 60 (FIG. 16 shows the third space 61 at different angles). The second speaker 30 and the third support 60 enclose a third cavity 93. The third cavity 93 is a part of the third space 61 (refer to FIG. 16). The third cavity 93 is a part of the rear cavity of the second speaker 30. It may be understood that in an embodiment, the rear cavity of the second speaker 30 may be a cavity enclosed by the diaphragm of the second speaker 30 and the third support 60.

The third cavity 93 communicates with the third support channel 62 of the third support 60. The third support channel 62 of the third support 60 communicates with the second air vent 112 of the housing 10. In this way, the second air vent 112 of the housing 10 communicates with the rear cavity of the second speaker 30. Air in the rear cavity of the second speaker 30 may communicate with air outside the earphone 100. The second air vent 112 is a rear vent of the rear cavity of the second speaker 30. The rear cavity of the second speaker 30 forms an open state. This improves equivalent compliance of the rear cavity of the second speaker 30, and improves low-frequency performance of the second speaker 30.

In an embodiment, the front cavity (including the second cavity 92 and the second through hole 44) and the rear cavity (including the third cavity 93) of the second speaker 30 are separated from each other, so that a propagation path (indicated by a solid line with an arrow in FIG. 18) of the sound wave in the front cavity of the second speaker 30 may be separated from a propagation path (indicated by a dashed line with an arrow in FIG. 18) of the sound wave in the rear cavity of the second speaker 30. In this way, the sound wave in the rear cavity of the second speaker 30 does not easily interfere with the sound wave in the front cavity of the second speaker 30. In other words, an acoustic short circuit does not easily occur in the second speaker 30 because the sound wave in the front cavity of the second speaker 30 is not coupled with the sound wave in the rear cavity of the second speaker 30. This improves sound quality of the front cavity of the second speaker 30, and avoids performance attenuation of the sound in the front cavity of the second speaker 30.

In addition, the rear cavity of the second speaker 30 is separated from the rear cavity (including the first cavity 91 and the first channel 45) of the first speaker 20, so that a propagation path (indicated by a solid line with an arrow in FIG. 18) of the sound wave in the rear cavity of the second speaker 30 may be separated from a propagation path (indicated by a dashed line with an arrow in FIG. 18) of the sound wave in the rear cavity of the first speaker 20.

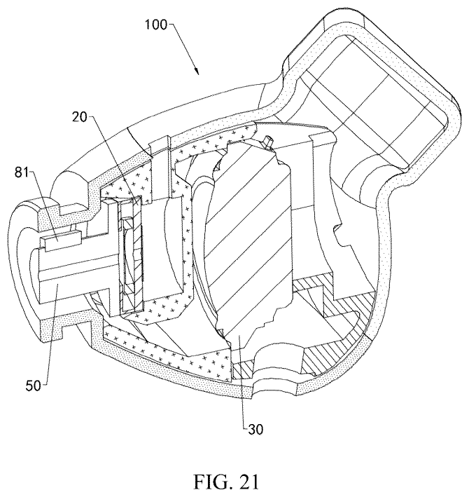

FIG. 19 is a schematic cross-sectional view of the part of the earphone 100 shown in FIG. 1 from a first angle according to another embodiment. The earphone 100 further includes a third mesh 73. The third mesh 73 is fastened between the housing 10 and the third support 60, and covers the second air vent 112 and the third support channel 62. In this way, the third mesh 73 may filter out impurities (such as dust) from air outside the earphone 100, and also adjust acoustic impedance of air in the rear cavity of the second speaker 30 to an extent. This improves sound quality of the earphone 100. It may be understood that FIG. 19 shows that the third mesh 73 is located between the housing 10 and the third support 60. In another embodiment, the third mesh 73 may be located in the third space 61, located in the third support channel 62, located in the second air vent 112, or located outside the earphone 100. In another embodiment, a mounting groove (not shown in the figure) is disposed on the housing 10, and the third mesh 73 is disposed in the mounting groove. In this way, the third mesh 73 is disposed on the housing 10, without increasing a thickness of the housing 10. In another embodiment, a mounting groove may alternatively be disposed on the third support 60, and the third mesh 73 is disposed in the mounting groove. In another embodiment, a shape of the third mesh 73 is not limited to the shape shown in FIG. 19. For example, the shape of the third mesh 73 may alternatively be an irregular shape. A part of the third mesh 73 is located between the housing 10 and the third support 60. A part of the third mesh 73 is disposed in the third support channel 62. A part of the third mesh 73 is disposed in the second air vent 112.

In an embodiment, the earphone 100 further includes a second sealing piece (not shown in the figure). The second sealing piece is fastened between the housing 10 and the first support 40. The second sealing piece may be disposed around the third mesh 73. It may be understood that the second sealing piece may cooperate with the third mesh 73, to prevent impurities (for example, dust or water stains) outside the earphone 100 from entering the earphone 100 through a gap between the housing 10 and the third support 60.

The foregoing describes several structures of the earphone 100 in detail with reference to the related accompanying drawings. The following further describes several structures of the earphone 100 in detail with reference to the related accompanying drawings.

FIG. 20 is a schematic cross-sectional view of the part of the earphone 100 shown in FIG. 1 from a first angle according to another embodiment. The earphone 100 further includes a feedforward reference microphone 81 (feedforward reference microphone). The feedforward reference microphone 81 may be configured to capture noise in an external environment of the earphone 100. The feedforward reference microphone 81 may be fastened to the first support 40 through bonding or the like, and is located in the front cavity of the second speaker 30. For example, the feedforward reference microphone 81 may be located in the second through hole 44 of the first support 40, located in the first through hole 43 (refer to FIG. 15) of the first support 40, or located at another position of the first support 40.

It may be understood that the first support 40 may provide an independent rear cavity for the first speaker 20, and the first support 40 may further provide a set position for the feedforward reference microphone 81. The first support 40 has an all-in-one function.

In another embodiment, a mounting groove (not shown in the figure) is disposed on the first support 40, and the feedforward reference microphone 81 is disposed in the mounting groove. In this way, the feedforward reference microphone 81 is disposed on the first support 40, without increasing a thickness of the earphone 100.

Refer to FIG. 20 again. The earphone 100 further includes a signal processing circuit 82. The signal processing circuit 82 may be fastened to the first support 40. The signal processing circuit 82 is electrically connected between the feedforward reference microphone 81 and the first speaker 20, or is electrically connected between the feedforward reference microphone 81 and the second speaker 30. For example, the signal processing circuit 82 includes a filter. It may be understood that in a noise reduction procedure, the feedforward reference microphone 81 may quickly capture noise (for example, noise in an ear canal) in the external environment of the earphone 100, and fitting is performed on the noise by using the signal processing circuit 82. In this way, a phase of the noise is converted into an opposite phase, and noise enters the ear canal through the first speaker 20 or the second speaker 30, to cancel out the normal-phase noise in the ear canal, to implement noise reduction effect.

In an embodiment, the earphone 100 further includes a residual noise reference microphone (residual noise reference microphone) (not shown in the figure). The residual noise reference microphone is configured to monitor a residual signal. The residual signal may be a normal-phase noise signal remaining after the normal-phase noise in the ear canal and the opposite-phase noise emitted by the first speaker 20 or the second speaker 30 cancel out each other. The residual noise reference microphone is fastened to the first support 40, and is located in the front cavity of the second speaker 30. For example, the residual noise reference microphone may be located in the first through hole 43 (refer to FIG. 15) of the first support 40, located in the second through hole 44 of the first support 40, or located at another position of the first support 40. It may be understood that the first support 40 may further provide a set position for the residual noise reference microphone. The first support 40 has more functions.

In another embodiment, a mounting groove (not shown in the figure) is disposed on the first support 40, and the residual noise reference microphone is disposed in the mounting groove. In this way, the residual noise reference microphone is disposed on the first support 40, without increasing a thickness of the earphone 100.

In an embodiment, the residual noise reference microphone is electrically connected to the feedforward reference microphone 81. It may be understood that in an actual application, it is difficult for the signal processing circuit 82 to perform phase-inversion fitting on all noise. Therefore, if the signal processing circuit 82 does not perform phase-inversion fitting on all noise, the residual noise reference microphone may monitor a residual signal, and feed back the residual signal to the feedforward reference microphone 81. In this way, the signal processing circuit 82 continues to perform phase-inversion fitting on the residual signal. A residual signal obtained after fitting is transmitted to the ear canal again. This is repeated until the noise transmitted from the signal processing circuit 82 to the ear canal completely cancels out the normal-phase noise captured directly in the ear canal.

It may be understood that stronger coherence between the noise captured by the residual noise reference microphone and the noise captured by the feedforward reference microphone 81 indicates better noise reduction effect. Coherence between the noise captured by the residual noise reference microphone and the noise captured by feedforward reference microphone 81 means causality between a noise signal captured by the residual noise reference microphone and a noise signal captured by the feedforward reference microphone 81, in other words, consistency between sound wave vibrations generated after the residual noise reference microphone and the feedforward reference microphone 81 capture the noise signals.

FIG. 21 is a schematic cross-sectional view of the part of the earphone 100 shown in FIG. 1 from a first angle according to another embodiment. The feedforward reference microphone 81 may also be fastened to the second support 50. It may be understood that the second support 50 may provide an independent front cavity for the first speaker 20, and the second support 50 may further provide a set position for the feedforward reference microphone 81. The second support 50 has an all-in-one function.

In addition, the signal processing circuit 82 and the residual noise reference signal may also be fastened to the second support 50.

In another embodiment, the feedforward reference microphone 81 may alternatively be fastened to another position in the front cavity of the second speaker 30.

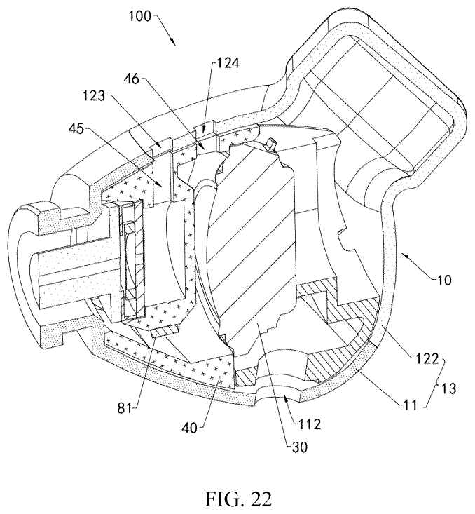

FIG. 22 is a schematic cross-sectional view of the part of the earphone 100 shown in FIG. 1 from a first angle in another embodiment. An air discharge channel 46 is disposed on the first support 40. The air discharge channel 46 is spaced from the first channel 45. The housing 10 is provided with a third air vent 124. The third air vent 124 is spaced from the first air vent 123 and the second air vent 112. The front cavity of the second speaker 30 communicates with the outside of the earphone 100 through the air discharge channel 46 and the third air vent 124.

It may be understood that when the earphone 100 is worn, air in the ear canal is continuously compressed as the sound outlet 111 is plugged into the ear canal. For example, in a procedure of wearing an in-ear earphone, the sound outlet 111 seals the ear canal, and pressure in the ear canal increases, resulting in uncomfortable wearing, and even damage to an eardrum of a user. In addition, because the ear canal communicates with the front cavity of the first speaker 20 and the front cavity of the second speaker 30, pressure in the front cavity of the first speaker 20 and pressure in the front cavity of the second speaker 30 also increase with the pressure in the ear canal. Consequently, this also affects acoustic performance of a bass frequency band of the earphone to an extent. However, in an embodiment, the front cavity of the second speaker 30 communicates with the outside of the earphone 100 through the air discharge channel 46 and the third air vent 124. In this way, when the earphone 100 is worn, an air flow in the ear canal is discharged to the external environment of the earphone through the air discharge channel 46 and the third air vent 124 in a procedure of continuously plugging the sound outlet 111 into the ear canal. This quickly balances the pressure in the ear canal, the pressure in the front cavity of the first speaker 20, and the pressure in the front cavity of the second speaker 30, to avoid uncomfortable wearing in the procedure of wearing the earphone. In addition, the pressure in the front cavity of the first speaker 20 and the pressure in the front cavity of the second speaker 30 do not easily increase with the pressure in the ear canal. This ensures that acoustic performance of the earphone 100 is not easily affected.

For example, the third air vent 124 is disposed away from the sound outlet 111 of the housing 10. For example, the third air vent 124 is disposed on the boss 122 of the rear housing 12. In this way, when the earphone 100 is worn on the ear, an inner wall of the cavum conchae or an inner wall of the ear canal does not block the third air vent 124, to avoid a problem that the third air vent cannot communicate with the outside of the earphone 100. This ensures stability of pressure relief in the front cavity of the second speaker 30.

In addition, the noise in the external environment of the earphone 100 may directly enter the front cavity of the second speaker 30 through the air discharge channel 46 and the third air vent 124, and enter the feedforward reference microphone 81 and the residual noise reference microphone. In other words, the air discharge channel 46 and the third air vent 124 may provide a new sound propagation path in which the noise is directly transferred from the external environment of the earphone 100 to the residual noise reference microphone. This improves coherence between the noise captured by the residual noise reference microphone and the noise captured by the feedforward reference microphone 81. In this way, the signal processing circuit 82 more accurately performs phase-inversion fitting on the residual signal, and noise reduction effect is further improved.

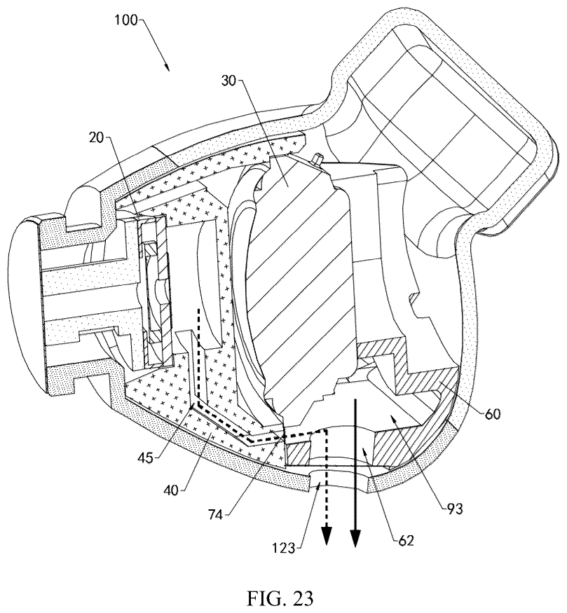

FIG. 23 is a schematic cross-sectional view of the part of the earphone 100 shown in FIG. 1 from a first angle in another embodiment. The first channel 45 communicates with the rear cavity of the second speaker 30. For example, the first channel 45 communicates with the third cavity 93 of the third support 60. The third cavity 93 communicates the first air vent 123 through the third support channel 62. In this way, the rear cavity of the first speaker 20 may communicate with the outside of the earphone 100 through the third cavity 93, the third support channel 62, and the first air vent 123. The rear cavity of the first speaker 20 forms the open state. This may improve equivalent compliance of the rear cavity of the first speaker 20, and improve low-frequency performance of the first speaker 20.

It may be understood that in comparison with solutions in the foregoing implementations, in an embodiment, a part of the rear cavity of the first speaker 20 is the same as a part of the rear cavity of the second speaker 30. In other words, the propagation path (indicated by a dashed line with an arrow in FIG. 23) of the sound wave in the rear cavity of the first speaker 20 overlaps at least partially with the propagation path (indicated by a solid line with an arrow in FIG. 23) of the sound wave in the rear cavity of the second speaker 30. In this way, the additional second air vent 112 does not need to be provided for the housing 10. The housing 10 has high overall strength and the housing 10 has good appearance consistency.

Refer to FIG. 23 again. The earphone 100 further includes a fourth mesh 74. The fourth mesh 74 is fastened between the first support 40 and the third support 60, and covers an opening that is of the first channel 45 and through which the first channel 45 communicates with the third space 61. In this way, the fourth mesh 74 may adjust the acoustic impedance of the air in the rear cavity of the first speaker 20 to an extent. This improves sound quality of the earphone 100. In another implementation, the fourth mesh 74 may alternatively be located in the first channel 45, or in the third space 61. In another embodiment, a mounting groove (not shown in the figure) is disposed on the first support 40, and the fourth mesh 74 is disposed in the mounting groove. In this way, the fourth mesh 74 is disposed on the first support 40, without increasing a thickness of the first support 40. In another embodiment, a shape of the fourth mesh 74 is not limited to the shape shown in FIG. 23. For example, the shape of the fourth mesh 74 may alternatively be an irregular shape. A part of the fourth mesh 74 is located between the first support 40 and the third support 60. A part of the fourth mesh 74 is disposed in the first channel 45.

In another embodiment, the first channel 45 may alternatively communicate with the first air vent 123 directly through the third support channel 62.

In another embodiment, the earphone 100 may alternatively include a fifth mesh (not shown in the figure). The fifth mesh is fastened between the housing 10 and the third support 60, and covers the first air vent 123 and the third support channel 62. Specifically, for a manner of disposing the fifth mesh, refer to the manner of disposing the third mesh 73 (refer to FIG. 19). Details are not described herein again.

The foregoing describes schematic diagrams of some structures of the earphone 100 with reference to the related accompanying drawings. In the foregoing descriptions, the first speaker 20 and the second speaker 30 are arranged in a front-to-back manner. In another embodiment, the first speaker 20 and the second speaker 30 may alternatively be arranged side by side. For example, for the earphone 100, positions of the first speaker 20, the first support 40, and the second support 50 are not changed, and both the second speaker 30 and the third support 60 are fastened to one side of the first support 40. In this way, the first speaker 20 still has independent front and rear cavities, and the second speaker 30 also has independent front and rear cavities. In another embodiment, when the first speaker 20 and the second speaker 30 are arranged side by side, the rear cavity of the first speaker 20 may share one cavity body with the rear cavity of the second speaker 30.

The foregoing descriptions are merely implementations of this application, but are not intended to limit the protection scope of this application. Any variation or replacement readily figured out by one of ordinary skilled in the art within the technical scope disclosed in this application shall fall within the protection scope of this application. If there is no conflict, the embodiments of this application and the features in the embodiments may be combined with each other. Therefore, the protection scope of this application shall be subject to the protection scope of the claims.

1. A sound output apparatus, comprising:
a housing enclosing an inner cavity, a sound outlet, and a first air vent, wherein the inner cavity communicates with outside of the housing through both the sound outlet and the first air vent;
a first channel and a second channel disposed on the housing, wherein the first channel communicates with the first air vent, and the second channel communicates with the sound outlet;
a first speaker is-fastened to the inner cavity of the housing, wherein a sound-emitting side of the first speaker faces the sound outlet, and a rear cavity of the first speaker communicates with the first channel; and
a second speaker is-fastened to the inner cavity and located on a side of the first speaker away from the sound outlet, wherein a front cavity of the second speaker communicates with the second channel.

2. The sound output apparatus according to claim 1, further comprising:
a first support mounted in the inner cavity of the housing, wherein the first channel is disposed on the first support; and
the first speaker is fastened to the first support, wherein the first speaker and the first support enclose a first cavity that is a part of the rear cavity of the first speaker.

3. The sound output apparatus according to claim 2, wherein the second channel is disposed on the first support; and
the second speaker is fastened to the first support, the second speaker and the first support enclose a second cavity separated from the first cavity, and the second cavity is a part of the front cavity of the second speaker.

4. The sound output apparatus according to claim 1, wherein the first speaker is a micro-electro-mechanical systems speaker and the second speaker is a moving-coil speaker.

5. The sound output apparatus according to claim 4, wherein operating frequency bands of the first speaker and the second speaker are in a range of 20 Hz to 20 kHz.

6. The sound output apparatus according to claim 2, further comprising:
a feedforward reference microphone fastened to the first support, wherein the feedforward reference microphone is configured to capture noise in an external environment of the sound output apparatus; and
a signal processing circuit located in the inner cavity of the housing, wherein the signal processing circuit is configured to receive the noise captured by the feedforward reference microphone and perform signal processing on the noise to convert a phase of the noise into an opposite phase, and the signal processing circuit is further configured to transmit opposite-phase noise to the first speaker or the second speaker, so that the first speaker or the second speaker emits a opposite-phase sound wave.

7. The sound output apparatus according to claim 2, further comprising:
a first mesh, wherein the first mesh is fastened between the housing and the first support, and covers the first air vent and the first channel.

8. The sound output apparatus according to claim 2, wherein the first support and a housing of the first speaker are in an integrally formed structure.

9. The sound output apparatus according to claim 1, further comprising:
a second support, wherein a second support channel is disposed on the second support, wherein the second support channel communicates with the sound outlet; and
the second support fastens the first speaker, wherein the second support channel is a part of a front cavity of the first speaker.

10. The sound output apparatus according to claim 9, wherein the second support comprises a fastening part and an extending part, the fastening part comprises a first surface and a second surface that are disposed opposite to each other, wherein the extending part is fastened to the first surface, a first opening of the second support channel is located on the second surface of the fastening part, and a second opening of the second support channel is located on a surface of the extending part away from the fastening part; and
the first speaker is fastened to the second surface of the fastening part.

11. The sound output apparatus according to claim 1, wherein the housing is further provided with a second air vent spaced from the first air vent and the sound outlet, and the inner cavity of the housing communicates with the outside of the housing through the second air vent;
the sound output apparatus further comprises a third support disposed on the third support; and
the third support fastens the second speaker, the third support and the second speaker enclose a third cavity, the third cavity is a part of a rear cavity of the second speaker, and the third cavity communicates with the second air vent through the third support channel.

12. The sound output apparatus according to claim 2, further comprising:
a third support wherein a third support channel is disposed on the third support, wherein
the third support fastens the second speaker, the third support channel communicates with the first air vent, the third support and the second speaker enclose a third cavity, the third cavity is a part of a rear cavity of the second speaker, and the third support channel communicates with the first channel through the third cavity.

13. The sound output apparatus according to claim 12, further comprising:
a fourth mesh, wherein the fourth mesh is fastened between the first support and the third support, and covers an opening that is of the first channel and through which the first channel communicates with the third cavity.

14. The sound output apparatus according to claim 2, wherein the housing is provided with a third air vent, the third air vent is spaced from the sound outlet and the first air vent, and the inner cavity of the housing communicates with the outside of the housing through the third air vent; and
an air discharge channel is further disposed on the first support, the air discharge channel is spaced from the first channel and the first cavity, and the front cavity of the second speaker communicates with the third air vent through the air discharge channel.

15. (canceled)

16. The sound output apparatus according to claim 2, wherein the first speaker is a micro-electro-mechanical systems speaker and the second speaker is a moving-coil speaker.

17. The sound output apparatus according to claim 3, wherein the first speaker is a micro-electro-mechanical systems speaker and the second speaker is a moving-coil speaker.

18. The sound output apparatus according to claim 3, further comprising:
a feedforward reference microphone fastened to the first support, wherein the feedforward reference microphone is configured to capture noise in an external environment of the sound output apparatus; and
a signal processing circuit located in the inner cavity of the housing, wherein the signal processing circuit is configured to receive the noise captured by the feedforward reference microphone and perform signal processing on the noise to convert a phase of the noise into an opposite phase, and the signal processing circuit is further configured to transmit opposite-phase noise to the first speaker or the second speaker, so that the first speaker or the second speaker emits a opposite-phase sound wave.

19. The sound output apparatus according to claim 4, further comprising:
a feedforward reference microphone fastened to the first support, therein the feedforward reference microphone is configured to capture noise in an external environment of the sound output apparatus; and
a signal processing circuit located in the inner cavity of the housing, wherein the signal processing circuit is configured to receive the noise captured by the feedforward reference microphone and perform signal processing on the noise to convert a phase of the noise into an opposite phase, and the signal processing circuit is further configured to transmit opposite-phase noise to the first speaker or the second speaker, so that the first speaker or the second speaker emits a opposite-phase sound wave.

20. The sound output apparatus according to claim 5, further comprising:
a feedforward reference microphone fastened to the first support, wherein the feedforward reference microphone is configured to capture noise in an external environment of the sound output apparatus); and
a signal processing circuit located in the inner cavity of the housing, wherein the signal processing circuit is configured to receive the noise captured by the feedforward reference microphone and perform signal processing on the noise to convert a phase of the noise into an opposite phase, and the signal processing circuit is further configured to transmit opposite-phase noise to the first speaker or the second speaker, so that the first speaker or the second speaker emits a opposite-phase sound wave.

21. The sound output apparatus according to claim 3, further comprising:
a first mesh, wherein the first mesh is fastened between the housing and the first support, and covers the first air vent and the first channel.
